(19) United States
(12) Patent Application Publication
(10) Pub. No.: US 2007/0009087 A1
(43) Pub. Date: Jan. 11, 2007

(54) Equipment and method for locating and identifying incrustations in ducts and in processing plants

(75) Inventor: Alberto Alves De Oliveira, Rio de Janeiro (BR)

Correspondence Address: NIXON & VANDERHYE, PC, 901 NORTH GLEBE ROAD, 11TH FLOOR, ARLINGTON, VA, 22203, US

(73) Assignee: PETROLEO BRASILEIRO S.A.

(21) Appl. No.: 11/481,056

(22) Filed: Jul. 6, 2006

(30) Foreign Application Priority Data
Jul. 7, 2005 (BR) PI 0503627-5

(51) Int. Cl. G01B 15/06; G01N 23/02

(52) U.S. Cl. 378/60

(57) ABSTRACT

Equipment (1) and a method for locating and identifying incrustations in ducts and processing plants are described. Records of physical variations of fundamental importance to learning the process by which the incrustations are formed inside ducts is obtained through an inlet of said duct in equipment for foreseeing, identifying, and locating inorganic incrustations within ducts. Said equipment (1) includes: a physical parameter recorder (2), containing sensors (3, 4, 5, 6, 7, 8, 9, 10, 11 and 12), data acquisition equipment (13, 14, 15, 17 and 18) and power generating equipment (16), housed in an elastomer pig (19), with a cavity (20). Said equipment (1) allows salt incrustations to be foreseen, notably barium sulfate, calcium sulfate, strontium sulfate, and radium sulfate, that occur inside ducts, guaranteeing in this way an uninterrupted flow of fluids through the duct in accordance with well defined criteria, during operation of production ducts and transport.

### CROSS REFERENCE TO RELATED APPLICATION

This application is based upon, claims the benefit of, priority of, and incorporates by reference, the contents of Brazilian Patent Application No. PI 0503627-5 filed Jul. 7, 2005.

### FIELD OF THE INVENTION

The present invention refers to equipment for locating and identifying incrustations in ducts and in processing plants. More specifically, the present invention refers to autonomous recording equipment capable of recording important physical changes in order to locate and identify incrustations along the inside of ducts and in processing plants.

### DESCRIPTION OF THE STATE OF THE ART

Exploration for oilfields involves several stages. Generally speaking, some of these stages include drilling production wells and a series of stages for drainage (production) of petroleum coming from these wells.

Oil companies all over the world use the technique of reinjecting system water, that is the water existing in the well reservoir, and injecting sea water, to maintain the pressure in reservoir high and sufficient, in order to guarantee maximum production of oil and gas at a feasible cost.

Various radionuclide elements are found within the system water, such as potassium, strontium, radium, thorium, and uranium. In practice, the presence of precipitates of strontium and radium together with calcium and barium is checked in the sea water, which is rich in sulfates and carbonate anions and forms sulfates and carbonates with low reactivity encouraging the formation of inorganic deposits on the walls of ducts and in processing plants. These inorganic deposits are known in the state of the art as incrustations having a high probability of radio nuclear activity.

To assure the flow of fluids inside ducts, monitoring internal conditions within these ducts is necessary, as well as the previous detection of these incrustations inside said ducts.

There are some patents that protect equipment and processes for the detection of incrustations of radioactive materials in piping. For example, European patent EP 0 442 813 protects a logging tool used to detect and quantify radioactive materials found in the casing of an oil well. That tool has limitations related to depth subject to probing, as the depth is linked to the length of the cable (known in the field as wire) available.

U.S. Pat. No. 3,778,613 protects equipment and a method of detecting leaks in underground piping. In this patent, a radioactive solution is pumped through piping and a radioactive detection “pig” is used to detect and record leaks, through the differences in radioactive emissions. Special attention is necessary when handling the radioactive solution, as well as environmental concerns resulting from leaks of the radioactive solution into an ecosystem.

The Brazilian patent PI 9700788-9 protects a device that measures the physical parameters of a fluid flowing inside a pipe. Said device allows for the transmission of data obtained to an external computer and is linked to another conduction device that moves about inside the pipe.

Using the equipment and methods currently in existence, the configurations of incrustation deposits are practically unrecognizable along ducts in operation, and it is not possible to see the processes through which said deposits occur. In this way, the state of the art is aimed at protecting equipment and providing a method with the goal of identifying and locating inorganic incrustations throughout ducts and processing plants.

### SUMMARY OF THE INVENTION

By providing equipment and method for locating and identifying incrustations in ducts and processing plants, the present invention envisions minimizing the limitations on probing distances and damage to the ecosystem, as well as generating sufficient data to create and develop a simulator capable of foreseeing the appearance or development of incrustations inside ducts and processing plants. Through this data, it is possible to develop a tool to use in the plans for ducts and processing plants that will minimize incrustation deposits in new units.

Therefore, recording physical variations is of fundamental importance to finding out the processes by which the incrustations are formed inside ducts and processing plants. This is obtained through equipment that records physical parameters. Said equipment allows salt incrustations containing radionuclide elements to be identified and located, notably barium sulfate, calcium sulfate, strontium sulfate, and radium sulfate, that occur inside ducts, guaranteeing in this way an uninterrupted flow of fluids through the duct in accordance with well defined criteria, during operation of production ducts and transport.

### BRIEF DESCRIPTION OF THE DRAWINGS

The equipment and method for locating and identifying incrustations in ducts and processing plants, the object of the present invention, will be better understood through the detailed description given below, with example headings, together with the drawings referenced below, which are an integral part of the present report.

FIG. 1 shows a view in perspective of autonomous recording equipment and of an elastomer pig to locate and identify incrustations in ducts and processing plants, in accordance with the present invention.

FIG. 1a shows a view in perspective of autonomous recording equipment and of an elastomer pig to locate and identify incrustations in ducts and processing plants, in accordance with a second aspect of the present invention.

FIG. 2 shows a view in perspective of an elastomer pig in accordance with the present invention.

FIG. 3 shows a rear view in perspective of autonomous recording equipment and of an elastomer pig.

FIG. 4 shows a view in perspective of autonomous recording equipment in accordance with the present invention.

FIG. 5 shows a schematic drawing of the autonomous recording equipment in accordance with the present invention.

### DETAILED DESCRIPTION OF THE INVENTION

The detailed description of the equipment and method to locate and identify incrustations in ducts and processing plants, the object of the present invention, shall be made in accordance with the identification of its respective components based on the above described figures. The invention intends to identify, accompany and locate with greater precision the appearance and development of incrustations inside ducts through recording relevant physical changes.

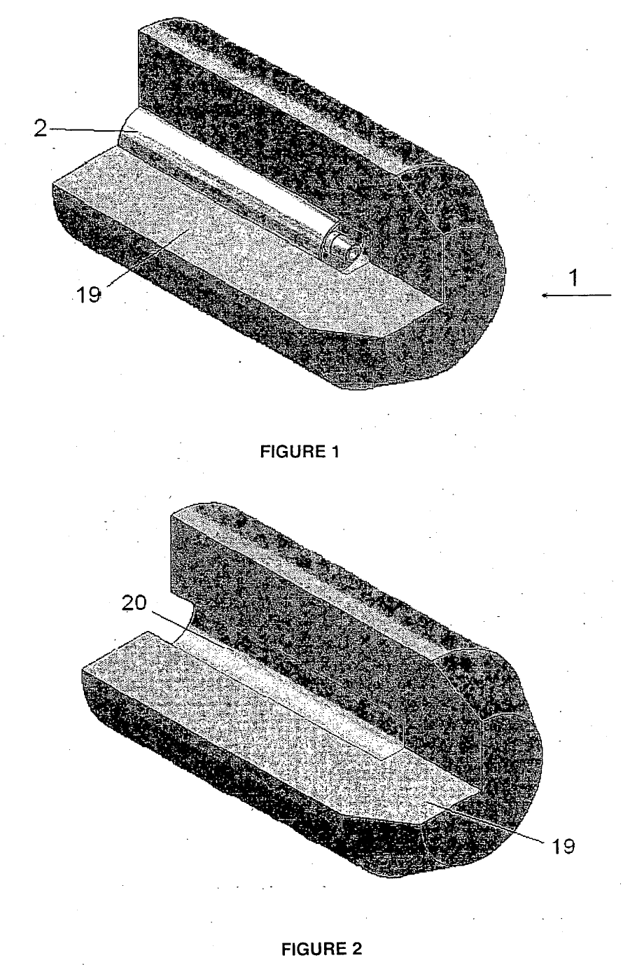

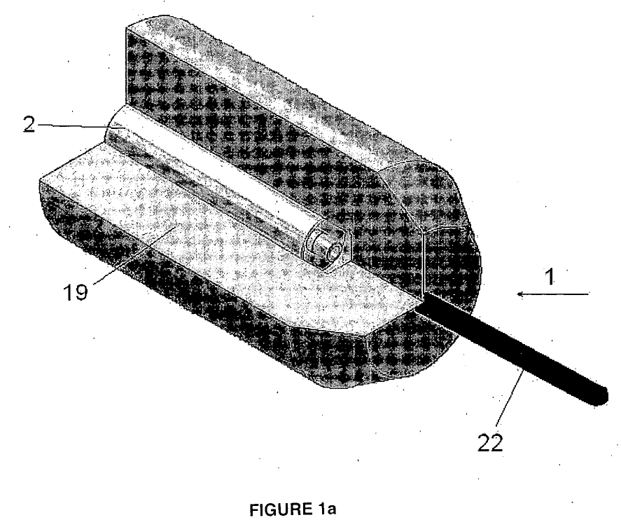

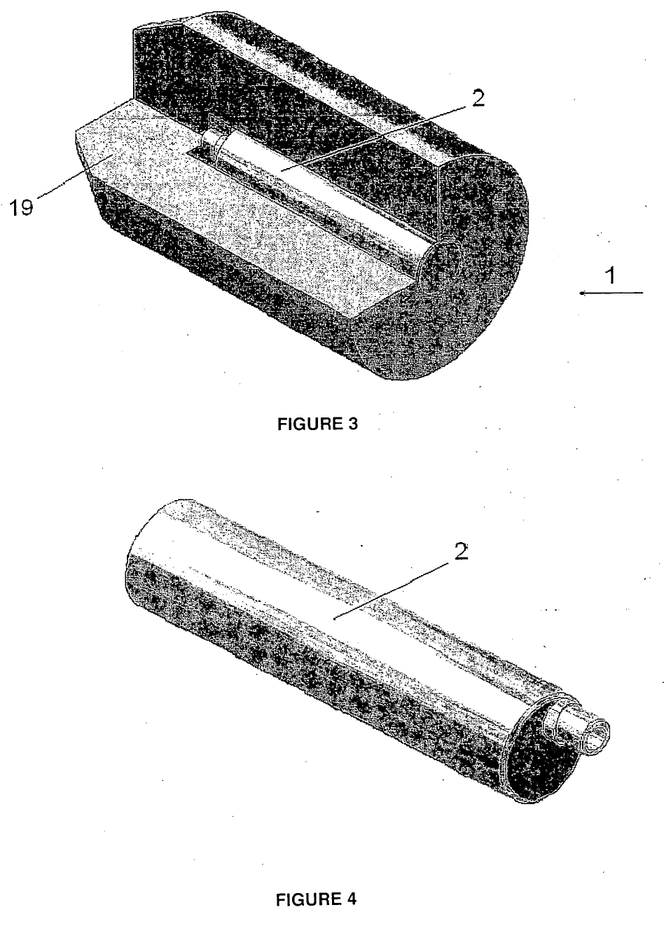

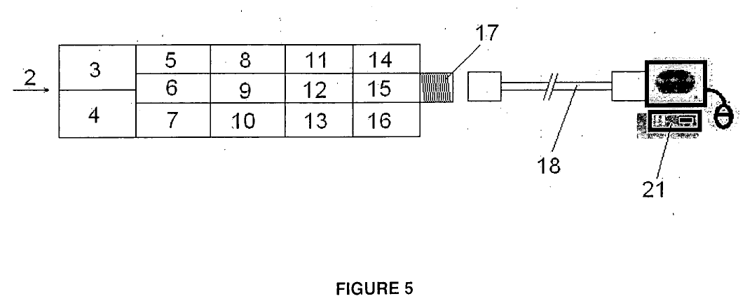

FIGS. 1, 1a, 2, 3, 4, and 5 show schematics of equipment (1) to locate and identify incrustations, in accordance with the present invention. Said equipment (1) includes:

an autonomous electronic recorder (2) which includes:

a temperature sensor (3), to measure temperature values ranging between 10° C. and 90° C., with a variation of precision of 0.1° C.;

a pressure sensor (4), to measure pressure values within a range of between 0 and 200 bar, with a variation of precision of 0.2 bar;

a differential pressure sensor (5) within the duct, to measure differential pressure values within a range of between 0 and 2 bar, with a variation of precision of 0.002 bar;

a longitudinal acceleration sensor (6), within the duct, to measure longitudinal acceleration values ranging between −2 g and 2 g, with a variation of precision of 0.002 g;

a vertical acceleration sensor (7), within the duct, to measure vertical acceleration values ranging between −2 g and 2 g, with a variation of precision of 0.002 g;

a horizontal acceleration sensor (8), within the duct, to measure horizontal acceleration values ranging between −2 g and 2 g, with a variation of precision of 0.002 g;

a longitudinal rotation sensor (9) to measure longitudinal rotation values ranging between 0 and 360 degrees;

a horizontal rotation sensor (10) to measure horizontal rotation values ranging between 0 and 360 degrees;

a vertical rotation sensor (11) to measure vertical rotation values ranging between 0 and 360 degrees;

an alpha, beta, gamma, and x-ray radiation sensor (12) to measure radiation emitted by the incrustations;

a unit for conversion of analog data to digital (13) in order to make possible recording it into electronic memory;

a digital control and processing unit (14) to manage the system of data acquisition from the equipment;

a non-volatile data storage unit (15) to store the data obtained;

a power unit (16) made up with batteries and a power management system to power the equipment;

an interface for communication (17) between the personal computer and the autonomous electronic recorder (2) to program and download data;

a cable with connectors (18), to establish a physical medium between the communication interface (17) and a computer; and

an elastomer pig (19), with a cavity (20) where the autonomous electronic recorder (2) is housed.

The recordings are simultaneously and autonomously performed for up to 50 uninterrupted hours. The data is stored in a non-volatile data storage unit (15) with a data acquisition rate in a range of occurrences between 10 and 100 samples per second.

In this way the equipment (1) allows probing of ducts of various diameters such as, for example, flexible lines, rigid ducts and processing plants.

Thus, a method to locate and identify incrustations in ducts and processing plants includes the following stages:

housing the autonomous electronic recorder (2) in a cavity (20) of a pig made of elastomer material (19), according to the nominal diameter of the duct to be probed;

passing the equipment (1), made up of the autonomous electronic recorder (2) and the elastomer pig (19) through the piping to be probed;

measurement and recording of physical variations: radioactivity, temperature, pressure (differential and absolute), acceleration (longitudinal, horizontal and vertical) and rotation (longitudinal horizontal and vertical), through an autonomous electronic recorder (2);

transference of all recorded data through a cable with connectors (18) that is connected to a communication interface (17) between the autonomous electronic recorder (2) and a computer (21); and

analysis of the recorded physical changes.

Therefore, the method proposed is based on measuring the radioactivity along the duct through an autonomous electronic recorder (2). The larger the deposits, the greater the obstruction and, consequently, the greater the radioactivity measured. It is also possible to determine the nature of the obstructions found in the duct such as, for example, tumbling home, corrosion, organic deposits, connections and/or misaligned valves or incrustations.

Alternately, the equipment (1) may be pulled with a steel or polymer cable (22).

Alternately, the recorded physical changes may generate sufficient data to create and develop a simulator capable of foreseeing the appearance and development of incrustations inside ducts and processing plants. The data periodically collected can be used in a computer modeling incrustation profile formation. By comparison with the real data acquired and the simulated data, it will be possible to develop, adjust and develop this simulator. Also, through this data, it is possible to develop a tool to use in the plans for ducts and processing plants that will minimize incrustation deposits in new units.

The description made here of the equipment and method to locate and identify incrustations in ducts and processing plants, the object of the present invention, should be considered only as a possibility or possible models, and any particular characteristics introduced herein should be understood only as something that was described to facilitate understanding. In this way, they should not in any way be considered as limitations of the invention, which is limited to the scope of the claims that follow.

1. Equipment for locating and identifying incrustations in ducts and processing plants comprising:
an autonomous electronic recorder which includes:
a temperature recorder, to record temperature values ranging between 10° C. and 90° C., with a variation of precision of 1° C.;
a pressure recorder, to record pressure values ranging between 0 and 200 bar, with a variation of precision of 0.2 bar;
a differential pressure recorder, to record differential pressure values ranging between 0 and 2 bar, with a variation of precision of 0.002 bar;
a longitudinal acceleration recorder, to record longitudinal acceleration values ranging between −2 g and 2 g, with a variation of precision of 0.002 g;
a vertical acceleration recorder, to record vertical acceleration values within a range of between −2 g and 2 g, with a variation of 0.002 g;
a horizontal acceleration recorder within the duct, to record horizontal acceleration values within a range of between −2 g and 2 g, with a variation of 0.002 g;
a longitudinal rotation sensor to measure longitudinal rotation values ranging between 0 and 360 degrees;
a horizontal rotation sensor to measure horizontal rotation values ranging between 0 and 360 degrees;
a vertical rotation sensor to measure vertical rotation values ranging between 0 and 360 degrees;
a alpha, beta, gamma, and x-ray radiation sensor to measure radiation emitted by the incrustations;
a unit for conversion of analog data to digital data in order to make possible recording it into electronic memory;
a digital control and processing unit to manage the system of data acquisition from the equipment;
a non-volatile data storage unit to store the data obtained;
a power unit made up with batteries and a power management system to power the equipment; and
an interface for communication between a computer and the autonomous electronic recorder to program and download data; and
an elastomer pig, with a cavity wherein said autonomous electronic recorder is housed.

2. Equipment for locating and identifying incrustations in ducts and processing plants in accordance with claim 1, further comprising a cable with connectors, to establish a physical medium between the communication interface and the computer.

3. Equipment for locating and identifying incrustations in ducts and processing plants in accordance with claim 1, wherein the recordings are simultaneously and autonomously performed for up to 50 uninterrupted hours.

4. Equipment for locating and identifying incrustations in ducts and processing plants in accordance with claim 1, wherein the non-volatile data storage unit has a data acquisition rate in a range of occurrences of between 10 and 100 samples per second.

5. Equipment for locating and identifying incrustations in ducts and processing plants in accordance with claim 1, characterized by said equipment allowing the probing of ducts of various diameters that may be selected among: flexible lines, rigid ducts, and processing plants.

6. Method for locating and identifying incrustations in ducts and processing plants, comprising:
housing an autonomous electronic recorder in a cavity of a pig made of elastomer material, according to the nominal diameter of a duct or piping to be probed;
passing the equipment made up of the autonomous electronic recorder and the elastomer pig through the duct or piping to be probed;
measuring and recording physical variations in radioactivity, temperature, pressure (differential and absolute), acceleration (longitudinal, horizontal and vertical) and rotation (longitudinal horizontal and vertical) through the autonomous electronic recorder; and
transferring all recorded data from the autonomous electronic recorder to a computer; and
analyzing the recorded physical changes to locate and identify incrustations.

7. Method for locating and identifying incrustations in ducts and processing plants in accordance with claim 6, characterized by determining the nature of obstructions found in the duct such as, for example, tumbling home, corrosion, organic deposits, connections and/or misaligned valves or incrustations.

8. Method for locating and identifying incrustations in ducts and processing plants in accordance with claim 6, characterized by the equipment being pulled through the duct or piping by a steel or polymer cable.

9. Method for locating and identifying incrustations in ducts and processing plants in accordance with claim 6, comprising creating and developing a simulator capable of foreseeing the appearance or development of incrustations inside ducts and processing plants from the data generated from the recorded physical changes.

10. Method for locating and identifying incrustations in ducts and processing plants in accordance to claim 9, characterized by creating and developing a simulator using the data periodically collected for a computer modeling incrustation profile formation, by comparison with the real data acquired and the simulated data.

11. Method for locating and identifying incrustations in ducts and processing plants in accordance with claim 5, comprising measuring and recording a plurality of said physical variations, simultaneously and autonomously for up to 50 uninterrupted hours.
